(19) United States
(12) Patent Application Publication
(10) Pub. No.: US 2026/0302954 A1
(43) Pub. Date: Oct. 1, 2026

(54) POWER SUPPLY UNIT FOR SUPPLYING POWER TO A RESISTANCE HEATING BAND

(71) Applicant: ROPEX Industrie-Elektronik GmbH, Bietigheim-Bissingen (DE)

(72) Inventor: Oliver FUCHS, Ilsfeld (DE)

(21) Appl. No.: 19/630,762

(22) Filed: Mar. 27, 2026

(30) Foreign Application Priority Data
Mar. 28, 2025 (EP) 25166888

(51) Int. Cl. H02M 3/335; H05B 3/02

(52) U.S. Cl. CPC H02M 3/335; H05B 3/02

(57) ABSTRACT

A power supply unit for the electrical supply of a resistive heating strip, including a DC-DC converter from the group: flyback converter, single-ended flux converter, push-pull flux converter in parallel mode, push-pull flux converter with half-bridge control, push-pull flux converter with full-bridge control. The DC-DC converter includes a supply circuit with a primary coil and a load circuit with a secondary coil. The primary coil and the secondary coil form a transformer. The supply circuit includes a parallel connection of the primary coil with a first diode group and a second diode group, both including a series connection of two diodes, and the supply circuit includes a series connection of the primary coil with a power transistor, which is electrically connected to a controller which is configured to control the power transistor depending on the provision of a supply voltage to the supply circuit.

### CROSS REFERENCE TO RELATED APPLICATION

This application claims priority to European Patent Application No. 25166888.5 filed Mar. 28, 2025, which is incorporated by reference.

### BACKGROUND

The invention relates to a power supply unit for supplying power to a resistance heating band.

The RES temperature controller, which is designed to supply power to a welding tool implemented as a resistance heating band, is known from the applicant’s product range. To this end, the RES temperature controller continuously measures the current and voltage supplied to the resistance heating band in order to regulate the temperature of the resistance heating band, wherein the resistance heating band serves as a temperature sensor. The measurement cycle is performed 50 times per second (50 Hz) or 60 times per second (60 Hz).

### SUMMARY

The objective of the invention is to provide a power supply unit for electrically powering a resistance heating band that has a simplified design.

This task is solved for a power supply unit of the type mentioned above by the fact that the power supply unit comprises a DC-DC converter (DC voltage converter) from the group: flyback converter, single-ended flux converter, push-pull flux converter in parallel mode, push-pull flux converter with half-bridge control, push-pull flux converter with full-bridge control, wherein the DC-DC converter comprises a supply circuit with a primary coil and a load circuit with a secondary coil, wherein the primary coil and the secondary coil form a transformer, wherein the supply circuit comprises a parallel connection of the primary coil with a first diode group comprising a series connection of two diodes, and with a second diode group comprising a series connection of two diodes, and wherein the supply circuit comprises a series connection of the primary coil with a power transistor, wherein the power transistor is electrically connected to a controller configured to control the power transistor depending on the supply of a DC voltage or a single-phase AC voltage or a two-phase AC voltage to the supply circuit.

DC-DC converters from the group: flyback converters, single-ended current converters, push-pull flux converters in parallel mode, push-pull flux converters with half-bridge control, and push-pull flux converters with full-bridge control are known from the prior art and are used in switching power supplies for electrical loads such as computers, mobile phones, and small motors that rely on a stable DC voltage supply. In applications with higher electrical power requirements, the negative impact that the DC converter and the connected electrical load exert on the power grid, referred to as grid reaction, must be kept below a level specified by the grid operator. To meet this requirement, the use of active power factor correction is common, which entails significant circuit design complexity.

To achieve the simplest possible circuit design for the power supply unit according to the invention, the power supply unit is optimized for electrical loads that exhibit a certain degree of inertia during operation and therefore do not rely on a stable output voltage or load voltage. Examples of such inert electrical loads include, in addition to resistive heating elements, lighting devices such as filament lamps or electric welding equipment. With such an electrical load, it can be accepted without functional limitations on its usability that the output voltage provided in the load circuit of the DC-DC converter, which supplies the electrical load, exhibits certain fluctuations. For example, it may be provided that, when the power supply unit is supplied with a single-phase AC mains voltage or a two-phase AC mains voltage, the output voltage oscillates at twice the frequency of the AC mains voltage when supplying electrical power to the load. This applies in the case where the load has no significant capacitive and/or inductive properties and can therefore be described as a resistive load.

When using the power supply unit to power a resistance heating band, it must be ensured that the output voltage provided by the power supply unit can be precisely set in order to maintain the temperature required for welding and/or cutting thermoplastic materials. However, due to the thermal inertia of the resistance heating band, it is sufficient if a resulting average temperature of the resistance heating band can be maintained using an average output voltage provided by the power supply unit, even though the output voltage is subject to significant fluctuations and the electrical power required to maintain the desired temperature for the resistance heating band is only provided when averaged over a longer period, preferably over half a power cycle.

By adapting the power supply unit to electrical loads that can tolerate fluctuations in the output voltage, provided that an average output voltage can be maintained precisely, it is possible to dispense with active power factor correction. This allows the electrical circuit design for the power supply unit to be kept simple, and components prone to wear, such as high-capacity capacitors, can be avoided.

Furthermore, a power supply unit controller designed to drive at least one power transistor arranged in the supply circuit can first determine the electrical supply available to the supply circuit. The controller can then drive the at least one power transistor based on the electrical supply and the characteristics of the load connected to the load circuit. The number of power transistors arranged in the supply circuit and, if necessary, additionally in the load circuit depends on the design of the DC-DC converter. In the simplest case, a flyback converter is used, which requires only a single power transistor in the supply circuit. In a single-ended flux converter and in a push-pull flux converter with a half-bridge, two power transistors are arranged in the supply circuit. In a push-pull flux converter with a full bridge, four power transistors are arranged in the supply circuit and four power transistors in the load circuit.

When a direct current is supplied to the supply circuit, for example by connecting the power supply unit to an accumulator or a battery, the first diode group and the second diode group are not used. In this case, the controller can drive the at least one power transistor in a manner that is advantageously adapted to the characteristics of the load connected to the load circuit, since there is no connection to an electrical grid and thus no grid reactions need to be taken into account.

A single- or two-phase (mains) AC voltage is supplied to the first and second diode groups, which is used to rectify the AC voltage. The controller drives the at least one power transistor such that a DC link voltage and the output voltage of the power supply unit oscillate at the same frequency as the rectified (mains) AC voltage. This advantageously allows a high power factor to be achieved, since the load current through the resistive load electrically connected to the load circuit, in particular through the resistive heating band, is proportional to the rectified AC voltage.

In such a design of the power supply unit, the transformer formed by a primary coil and a secondary coil can be configured as a cost-effective high-frequency transformer.

Advantageous embodiments of the invention are the subject of the subclaims.

It is advantageous for the supply circuit to comprise a parallel connection of the primary coil with a third diode group, which comprises a series connection of two diodes, and for the control to be configured to drive the power transistor in response to the provision of a three-phase AC voltage to the supply circuit. By additionally providing a third diode group, which is arranged in parallel with the primary coil as well as with the first and second diode groups, a supply of three-phase (mains) AC voltage to the power supply unit can be provided. The controller is configured to detect the provision of the three phases to the three diode groups and to drive the at least one power transistor accordingly.

Preferably, the supply circuit includes a series connection of the primary coil with an intermediate circuit coil (DC-link coil) and a parallel connection of the primary coil with an intermediate circuit capacitor (DC-link capacitor), wherein the intermediate circuit coil and the intermediate circuit capacitor form a low-pass filter with a cutoff frequency of at least 3 kHz, preferably at least 4 kHz, in particular at least 5 kHz. The combination of the intermediate circuit coil and the intermediate circuit capacitor enables buffering of the switching frequency of the at least one power transistor, which is at least 100 times higher than the frequency of the (mains) AC voltage. Conversely, it is not necessary to perform filtering in the range of the frequency of the (mains) AC voltage, so that the intermediate circuit capacitor can be implemented with a significantly smaller capacitance compared to a power supply unit known from the prior art, without thereby disregarding the requirements of the grid operators with regard to grid reaction. By way of example, it can be assumed that the intermediate circuit capacitor for the power supply unit according to the invention has a capacitance that is less than 5 percent of the capacitance of an intermediate circuit capacitor for a power supply unit known from the prior art. Due to the low DC-link capacitance, the effort required to limit the inrush current is also significantly reduced or can even be eliminated entirely.

It is preferably provided that, when the power supply unit is optimized for a resistive heating band for welding and/or cutting plastic films, the capacitance of the intermediate circuit capacitor in the power supply unit according to the invention is less than 50 microfarads, preferably less than 25 microfarads, more preferably less than 15 microfarads, and in particular less than 10 microfarads. The electrical output power for a power supply unit of the invention optimized in this manner may, by way of example, be in a range of 2000 watts to 10000 watts.

It is particularly advantageous if the intermediate circuit capacitor has a capacitance selected such that a DC link voltage and a load voltage oscillate at a frequency corresponding to the frequency of a rectified, single-phase, two-phase, or three-phase supply voltage when power is delivered to an ohmic load. In the case of a single-phase or two-phase supply voltage, the DC link voltage and the load voltage are thus intended to oscillate at twice the mains frequency. In the case of a three-phase supply voltage, the DC link voltage and the load voltage are thus intended to oscillate at six times the mains frequency.

Since the load current is proportional to the rectified mains voltage in this case, a favorably high power factor is ensured for the power supply unit with the resistive load connected to it, so that power factor correction is not required. Compared to known power supplies designed to power resistive heating bands, this results in a simpler design and eliminates the need for high-capacity capacitors.

In a further embodiment of the invention, the controller is configured to measure the temporal variation of the DC link voltage and to switch between different drive frequencies for the power transistor when the supply voltage is switched between single-phase, two-phase, or three-phase operation. This enables automatic adaptation of the drive of the at least one power transistor to different supply conditions. For example, if the power supply unit is initially supplied with a three-phase supply voltage, the at least one power transistor is driven at a first drive frequency. If, for example, a defect causes one of the phases of the supply voltage to fail, resulting in only a two-phase supply voltage, this is detected by the controller and the drive frequency is adjusted.

It is advantageous if the controller is designed to adjust the drive frequency used for the cyclic control of the power transistor proportionally to an DC link voltage (intermediate circuit voltage) in the supply circuit. By varying the drive frequency in proportion to the currently applied DC link voltage, both a minimization of switching losses for the at least one power transistor is achieved and a consistent magnetic modulation of the transformer formed by the primary coil, the secondary coil, and an associated ferrite core is ensured. This is possible for both a sinusoidal and a non-sinusoidal waveform of the supply voltage.

Preferably, the controller is electrically connected to a sensor configured to provide a sensor signal dependent on the temperature of a resistance heating band. With the aid of the sensor, which may in particular be the resistance heating band, temperature control for the welding process is enabled. Preferably, the controller is configured to influence the temperature of the resistance heating band by means of pulse width modulation of the DC link voltage. To this end, the current temperature of the resistance heating band is determined by measuring its electrical resistance, and an electrical power requirement for the resistance heating band is calculated based on the difference between the current temperature and a setpoint temperature. This power requirement is converted by the controller, depending on the supply voltage and the electrical properties of the transformer and the resistance heating band, into a specification for a pulse duration with which the at least one power transistor is driven.

The problem of the invention is also solved by a method for supplying electrical power to a resistance heating band, wherein it is provided that, upon supplying a single-phase supply voltage or a two-phase supply voltage to a supply circuit of a DC-DC converter from the group: flyback converter, single-ended flux converter, push-pull flux converter in parallel mode, push-pull flux converter with half-bridge control, push-pull flux converter with full-bridge control, a load voltage is supplied to a load circuit of the DC-DC converter in phase with the supply voltage. This ensures a beneficially high power factor for the power supply unit with the resistive load connected thereto, so that power factor correction can be dispensed with.

In a further embodiment of the method, it is provided that a controller of the DC-DC converter drives a power transistor in a supply circuit depending on the provision of a single-phase or two-phase supply voltage. In this context, it is provided that the control of the at least one power transistor is automatically adapted to different supply conditions in order to always ensure an optimal power factor and minimal grid reaction (network feedback) for the power supply unit.

To this end, a further embodiment of the method may provide that the controller determines a DC link voltage in the DC-to-DC converter’s supply circuit and sets a drive frequency for the power transistor proportional to the determined DC link voltage. This enables automatic adjustment of the drive frequency to the respective power supply unit situation for the power supply unit, which can vary between a single-phase, two-phase, or three-phase AC supply or a DC supply, without requiring any modifications in the circuitry. Rather, it is provided that the controller sets the respective drive frequency for the at least one power transistor and the respective pulse width modulation for driving the at least one power transistor depending on the power supply unit situation as well as on the power demand of the connected electrical load, in particular the resistive heating band. To this end, it is preferably provided that the controller uses a sensor signal from a temperature sensor for the pulse width modulation of the drive frequency for the power transistor.

In a further embodiment of the method, it is provided that, in a configuration of the DC-DC converter as a push-pull flux converter with full-bridge control, the controller uses phase-shifted pulse width modulation of the drive frequency for the power transistor to achieve a switching operation of the power transistor at vanishing voltage. This type of control of the at least one power transistor is also referred to as “zero voltage switching” and serves to reduce the electrical switching losses of the at least one power transistor to the lowest possible level.

In particular, the method for supplying electrical power to a resistive heating band comprises the steps: supplying a single-phase supply voltage or a two-phase supply voltage to a supply circuit of a DC-DC converter from the group: flyback converter, single-ended current converter, push-pull flux converter in parallel mode, push-pull flux converter with half-bridge control, push-pull flux converter with full-bridge control, and supplying a load voltage to a load circuit of the DC-DC converter in phase with the supply voltage.

According to a further aspect of the method, a controller of the DC-DC converter drives a power transistor in a supply circuit in response to the provision of a single-phase or two-phase supply voltage.

According to a further aspect of the method, the controller determines an intermediate circuit voltage in the supply circuit of the DC-DC converter and sets a drive frequency for the power transistor proportional to the determined DC link voltage.

According to a further aspect of the method, the controller uses a sensor signal from a temperature sensor for pulse width modulation of the drive frequency for the power transistor.

According to a further aspect of the method, in a configuration of the DC-DC converter as a push-pull flux converter with full-bridge control, the controller uses phase-shifted pulse width modulation of the drive frequency for the power transistor to achieve a switching operation of the power transistor at vanishing voltage.

Advantageous embodiments of the invention are illustrated in the drawings. Here,

### BRIEF DESCRIPTION OF THE DRAWINGS

FIG. 1 shows a schematic diagram of a first embodiment of a power supply unit based on a flyback converter,

FIG. 2 shows a schematic diagram of a second embodiment of a power supply unit based on a single-ended flux converter,

FIG. 3 a schematic diagram of a third embodiment of a power supply unit based on a push-pull flux converter with a half-bridge in the primary circuit and passive rectification in the secondary circuit, and

FIG. 4 a schematic diagram of a fourth embodiment of a power supply unit based on a push-pull flux converter with a full bridge in the primary circuit and synchronous rectification in the secondary circuit.

### DETAILED DESCRIPTION

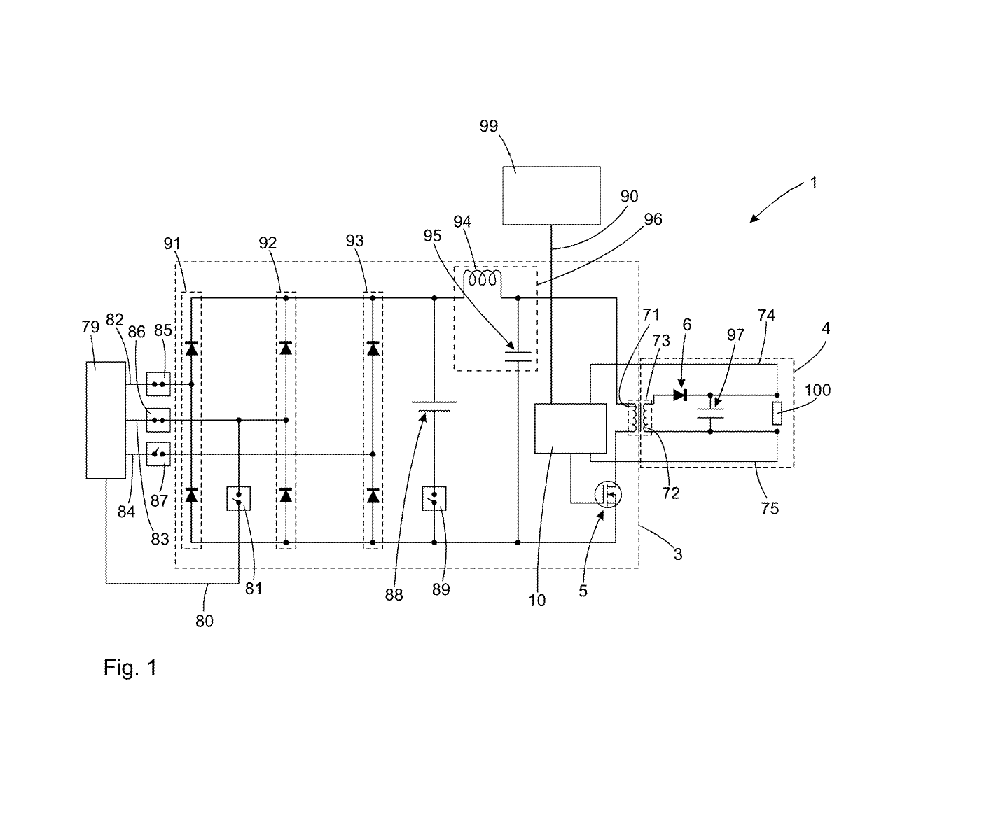

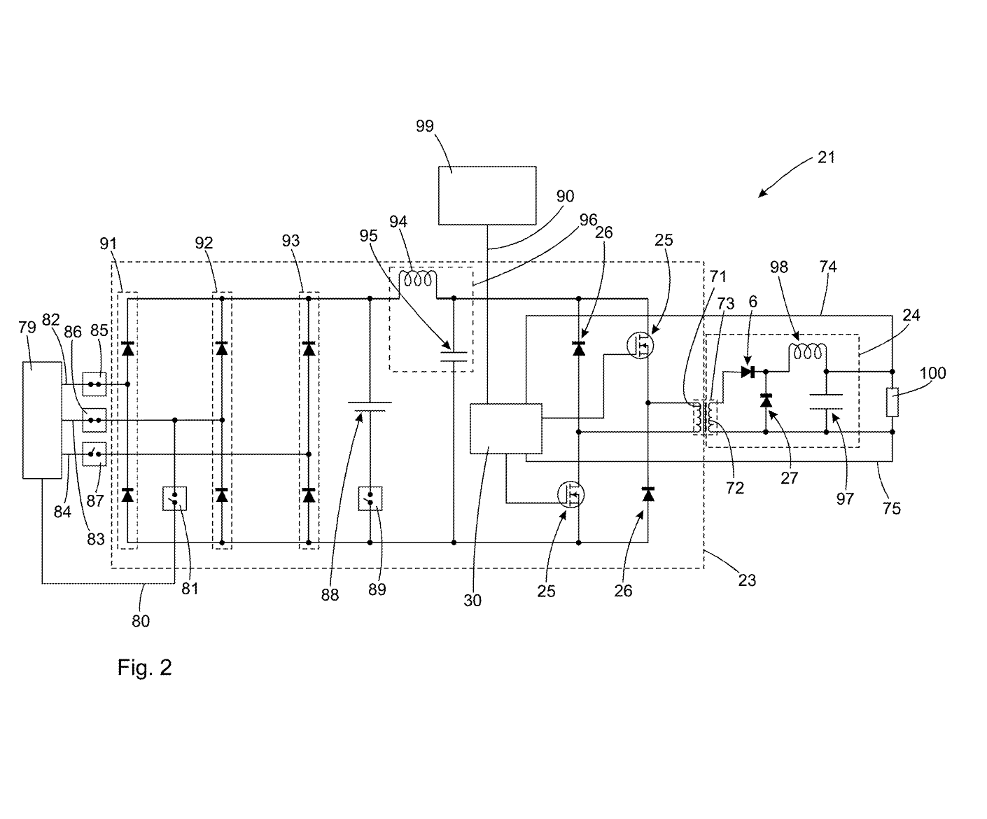

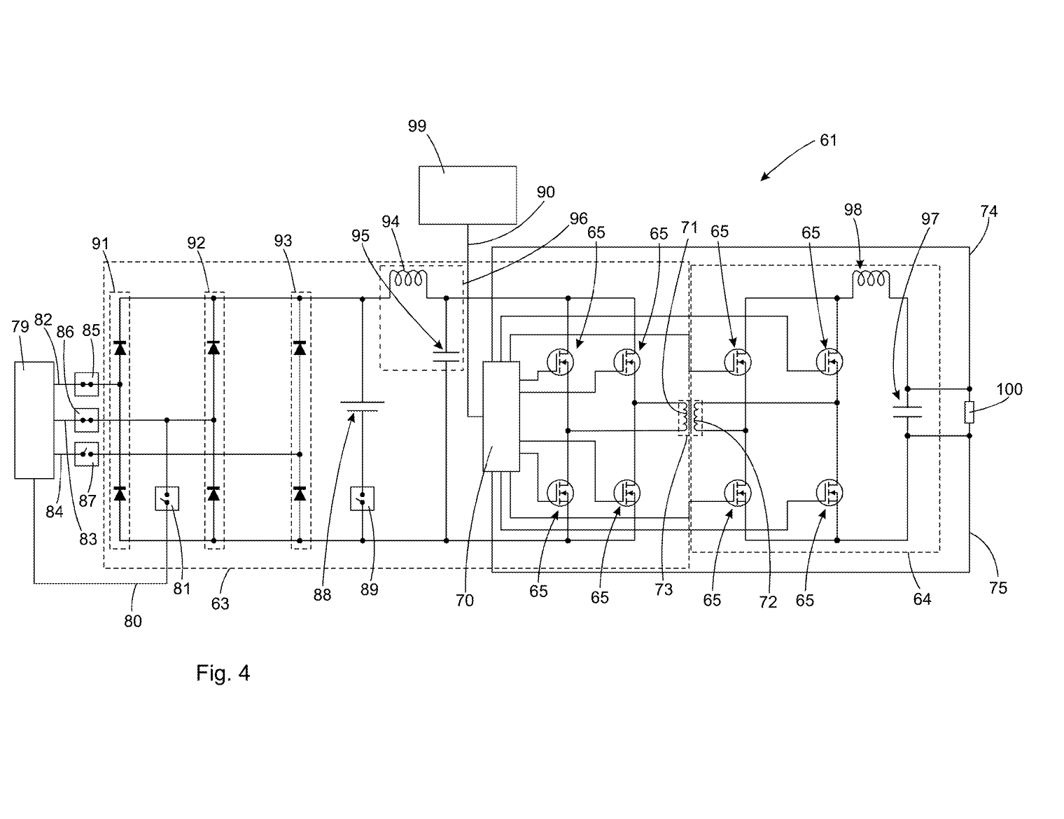

In the following description of FIGS. 1-4, the same reference numerals are used for components performing the same function.

The embodiments of power supplies 1, 21, 41, 61 shown in FIGS. 1-4 are each to be understood merely as examples, since for each of the DC-DC converters from the group: flyback converters, single-ended current converters, push-pull flux converters in parallel supply, push-pull flux converters with half-bridge control, and push-pull flux converters with full-bridge control alternative circuitry is available. The push-pull flux converters als may be named push-pull current converters.

The AC voltage source 79 shown in FIGS. 1-4, together with the neutral conductor 80 and neutral switch 81, as well as the first through third phase conductors 82, 83, 84 and the associated first through third phase switches 85, 86, 87, and the DC voltage source 88 with the associated DC voltage switch 89 symbolize the respective possible electrical power supplies for the power supplies 1, 21, 41, 61. In a practical configuration of the power supplies 1, 21, 41, 61, the neutral switch 81, the phase switches 85, 86, 87, and the DC voltage switch 89 are not present, since power is supplied either by single-phase, two-phase, or three-phase alternating current, or by direct current.

In the case of a single-phase AC power supply unit to power supplies 1, 21, 41, and 61, which is not shown in the drawings, neutral switch 81 and the first phase switch 85 are closed, while the second and third phase switches 86, 87 and the DC voltage switch 89 are open.

By way of example, it is provided that power supplies 1, 21, 41, and 61 are each supplied with two-phase alternating current. Accordingly, the first phase switch 85 and the second phase switch 86 are closed, while the neutral switch 81, the third phase switch 87, and the DC voltage switch 89 are open.

In the case of a three-phase AC power supply, which is not shown in the drawings, to power supply units 1, 21, 41, 61, all phase switches 85, 86, 87 are closed, while the DC voltage switch 89 and the neutral switch 81 are open.

In the case of a DC voltage supply, which is not shown in the drawings, to power supply units 1, 21, 41, and 61, the DC voltage switch 89 is closed, while the phase switches 85, 86, 87 and the neutral conductor switch 81 are open.

In order to supply the power supply units 1, 21, 51, and 61 with a single-phase, two-phase, or three-phase AC voltage or a DC voltage in a freely selectable manner and without circuit modifications, each of the power supply units 1, 21, 41, 61 in the respective supply circuit 3, 23, 43, 63 comprises a first diode pair 91, also referred to as the first diode group, a second diode pair 92, also referred to as the second diode group, and a third diode pair 93, also referred to as the third diode group. Each of the diode pairs 91, 92, 93 comprises a series connection of two individual diodes and is configured to rectify an AC voltage connectable to the respective phase line 82, 83, 84. The diode pairs 91, 92, and 93 each form a bridge rectifier for an AC phase and are each connected in parallel with one another as well as in parallel with a low-pass capacitor 95, also referred to as an intermediate circuit capacitor.

The supply circuit 3 of the power supply unit 1 shown in FIG. 1 further comprises a series connection of a primary coil 71 and a power transistor 5, wherein this series connection is in turn arranged in parallel with the diode pairs 91, 92, 93 as well as in parallel with the low-pass capacitor 95. The low-pass capacitor 95, together with a low-pass coil 94, also referred to as an intermediate circuit coil, which is arranged in a series connection between the diode pairs 91, 92, 93 and the primary coil 71, forms a low-pass filter 96. The function of the low-pass filter 96 is to block the high-frequency disturbances in the supply current caused by the switching of the power transistor 5 in the direction of the phase lines 82, 83, 84 and the DC voltage source 88.

Furthermore, the power supply unit 1 comprises a load circuit 4, which is configured as a series connection of a secondary coil 72, a rectifier diode 6, and a buffer capacitor 97. An electrical load 100, configured purely by way of example as a resistive heating band 100, is connected in parallel with the buffer capacitor 97.

Furthermore, the controller 10 is connected to the resistance heating band 100 via sensor lines 74, 75 in order to detect the electrical resistance of the resistance heating band 100 and thereby determine the temperature of the resistance heating band 100.

The controller 10, which may, for example, be configured as a microprocessor running a computer program, is responsible for providing temperature control for the resistance heating band 100. To this end, the controller 10 receives a setpoint temperature signal via a communication line 90 from a higher-level controller 99, which may, for example, be a machine controller of a film sealing machine (not shown), in particular a programmable logic controller (PLC).

By way of example, the setpoint temperature signal can be varied by the higher-level controller 99 between a first signal level, which corresponds to an ambient temperature value of, for example, 20 degrees Celsius, and a second signal level, which corresponds to a sealing temperature value of, for example, 250 degrees Celsius. The task of the controller 10 is then to drive the power transistor 5 in such a way that the resistive heating band 100 is supplied with electrical power by the power supply unit 1 so that the respective setpoint temperature is reached. For this purpose, the power transistor 5 is driven, for example, with a pulse-width-modulated drive signal.

Preferably, when power supply unit 1 is supplied with a single-phase, two-phase, or three-phase alternating voltage, a drive frequency for controlling power transistor 5 is selected that varies at twice the frequency of the supplied alternating voltage. The controller 10 can automatically adjust the drive frequency for the power transistor 5 depending on the respective electrical supply to the power supply unit 1 and, for this purpose, includes a corresponding program section in the computer program running in the microprocessor of the controller 10.

In particular, the computer program of the controller 10 can perform a dynamic switching of the drive frequency for the power transistor 5 if, for example, a phase supplied by the AC voltage source 79 is lost. In this context, the controller 10 is designed to always select the optimal pulse width modulation frequency appropriate to the current electrical supply and the resulting voltage level. By adjusting the drive frequency proportionally to the currently applied DC link voltage, both switching losses are minimized and core losses are reduced, while ensuring consistent magnetic modulation of the transformer 73 formed by the primary coil 71, the secondary coil 72, and a ferrite core (not shown). This is possible even when the mains voltage has a non-sinusoidal waveform.

Specifically, the controller 10 measures the currently applied supply voltage and calculates the pulse duration of the next pulse width modulation period based on the desired magnetic flux change, so that the desired magnetic modulation of the ferrite core of the transformer 73 is achieved.

The electrical power supplied to the resistance heating strip 100 preferably oscillates at twice the frequency of the supplied AC voltage. This is acceptable for performing a welding process on plastic films due to the thermal inertia of the resistance heating strip 100 and results in power supply unit 1 being able to operate with an electrical power factor of nearly 100 percent. This is due to the fact that the current and voltage in the supply circuit 3 of the power supply unit 1 are proportional to each other.

The power supply unit 21 comprises a single-phase flux converter in which, unlike the power supply unit 1, a parallel connection of two power transistors 25 is provided in the supply circuit 23, wherein a rectifier diode 26 is connected upstream of one power transistor 25 and a rectifier diode 26 is connected downstream of the other power transistor 25. Both power transistors 25 and both rectifier diodes 26 are each arranged in identical polarity and in parallel with the primary coil 71 in the supply circuit 23. The load circuit 24 is configured as a series connection of the secondary coil 72, the rectifier diode 6, a load coil 98, and the buffer capacitor 97. In addition, a further rectifier diode 27 is provided, which is arranged in parallel with the buffer capacitor 97 and connected to a first end of the load coil 98, while the buffer capacitor 97 is connected to a second end of the load coil 98. The electrical load 100, configured as a resistance heating band 100, is connected in parallel with the buffer capacitor 97.

The controller 30 is configured to supply drive signals to the two power transistors 25. Furthermore, the controller 30 is connected to the resistance heating band 100 via sensor lines 74, 75 in order to detect the electrical resistance of the resistance heating band 100 and thereby determine the temperature of the resistance heating band 100.

The mode of operation for the controller 30 is directed toward the same objectives as the mode of operation for the controller 10 described above, so that, with regard to the mode of operation for the controller 30, reference can be made to the preceding descriptions of the mode of operation of the controller 10.

The power supply unit 41 comprises a push-pull current transformer, in which a series connection of two power transistors 45 is connected in parallel with a series connection of two capacitors 46 in the supply circuit 43. The primary coil 71 is electrically connected with a first coil end between the two power transistors 45 and with a second coil end between the two capacitors.

On the secondary side of the transformer 73, the secondary coil 72 is electrically connected at a first coil end to a first series connection of rectifier diodes 47 and at a second coil end to a second series connection of rectifier diodes 47, which form a passive bridge rectifier for the load circuit 44. The two series connections of rectifier diodes 47 are connected in parallel with the buffer capacitor 97. The load coil 98 is arranged between the two series connections of rectifier diodes 47 and the buffer capacitor 97.

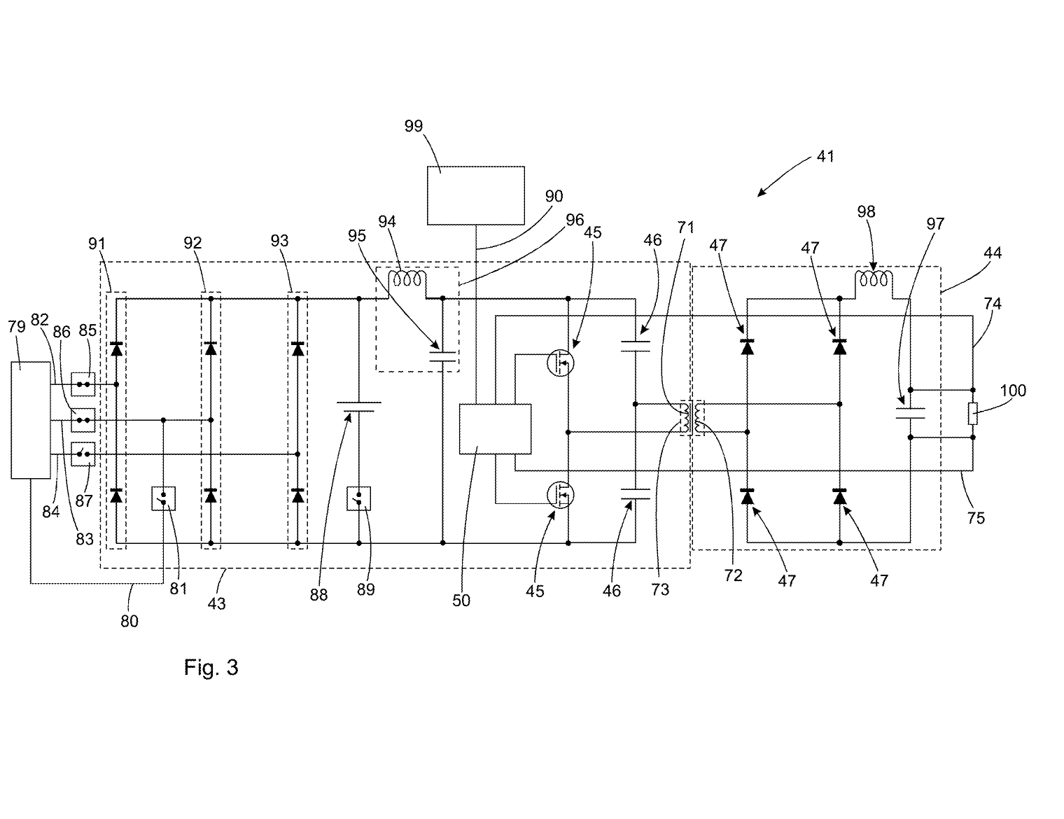

The push-pull flux converter shown in FIG. 3 is also referred to as a push-pull flux converter with a half-bridge in the primary circuit and passive rectification in the secondary circuit.

The electrical load 100, configured as a resistive heating band 100, is connected in parallel with the buffer capacitor 97.

The controller 50 is configured to provide drive signals to the two power transistors 45. Furthermore, the controller 50 is connected to the resistive heating strip 100 via sensor lines 74, 75 in order to detect the electrical resistance of the resistive heating strip 100 and thereby determine the temperature of the resistive heating strip 100.

The operating mode of the controller 50 is directed toward the same objectives as the operating mode of the controller 10 described above, so that reference can be made to the preceding descriptions of the operating mode of the controller 10 with regard to the operating mode of the controller 50.

The power supply unit 61 comprises a push-pull flux converter configured with a full bridge in the primary circuit and with synchronous rectification in the secondary circuit.

In this configuration, a first series connection of two power transistors 65 is connected in parallel with a second series connection of two power transistors 65 in the supply circuit 63. The primary coil 71 is electrically connected with a first coil end between the two power transistors 65 of the first series connection of power transistors 65 and with a second coil end between the two power transistors 65 of the second series connection of power transistors 65.

On the secondary side of the transformer 73, the secondary coil 72 is electrically connected at a first coil end to a third series connection of power transistors 65 and at a second coil end to a fourth series connection of power transistors 65, which form an active bridge rectifier for the load circuit 64. The two secondary-side series connections of the power transistors 65 are connected in parallel with the buffer capacitor 97. The load coil 98 is arranged between the two series connections of power transistors 65 and the buffer capacitor 97.

The electrical load 100, configured as a resistance heating band 100, is connected in parallel with the buffer capacitor 97.

The controller 70 is configured to provide drive signals to the total of eight power transistors 45. Furthermore, the controller 50 is connected to the resistive heating strip 100 via sensor lines 74, 75 in order to detect the electrical resistance of the resistive heating strip 100 and thereby determine the temperature of the resistive heating strip 100.

The operating mode of the controller 70 is directed toward the same objectives as the operating mode of the controller 10 described above, so that reference can be made to the preceding descriptions of the operating mode of the controller 10 with regard to the operating mode of the controller 70.

1. A power supply unit for the electrical supply of a resistive heating strip, comprising a DC-DC converter from the group: flyback converter, single-ended flux converter, push-pull flux converter in parallel mode, push-pull flux converter with half-bridge control, push-pull flux converter with full-bridge control, wherein the DC-DC converter comprises a supply circuit with a primary coil and a load circuit with a secondary coil, wherein the primary coil and the secondary coil form a transformer, wherein the supply circuit comprises a parallel connection of the primary coil with a first diode group, which comprises a series connection of two diodes, and with a second diode group, which comprises a series connection of two diodes, and wherein the supply circuit comprises a series connection of the primary coil with a power transistor, wherein the power transistor is electrically connected to a controller which is configured to control the power transistor depending on the provision of a DC voltage or a single-phase AC voltage or a two-phase AC voltage to the supply circuit.

2. The power supply unit according to claim 1, wherein the supply circuit comprises a parallel connection of the primary coil with a third diode group, which comprises a series connection of two diodes, and wherein the controller is configured to control the power transistor depending on the provision of a three-phase AC voltage to the supply circuit.

3. The power supply unit according to claim 1, wherein the supply circuit comprises a series connection of the primary coil with an intermediate circuit coil and a parallel connection of the primary coil with an intermediate circuit capacitor, wherein the intermediate circuit coil and the intermediate circuit capacitor form a low-pass filter with a cutoff frequency of at least 3 kHz.

4. The power supply unit according to claim 3, wherein the intermediate circuit capacitor has a capacitance selected such that an intermediate circuit voltage and a load voltage oscillate at a frequency corresponding to the frequency of the rectified AC voltage when power is delivered to an ohmic load.

5. The power supply unit according to claim 4, wherein the controller is configured to measure a temporal profile of the DC link voltage and to switch between different drive frequencies for the power transistor when switching the supply voltage between single-phase, two-phase, or three-phase operation.

6. The power supply unit according to claim 3, wherein the intermediate circuit capacitor has a capacitance of less than 50 microfarads.

7. The power supply unit according to claim 1, wherein the controller is configured to adjust the drive frequency used for the cyclic driving of the power transistor proportionally to a DC link voltage in the supply circuit.

8. The power supply unit according to claim 1, wherein the controller is electrically connected to a sensor configured to provide a sensor signal dependent on a temperature of a resistive heating band.

9. A method for supplying electrical power to a resistive heating band, wherein, when supplying a single-phase supply voltage or a two-phase supply voltage to a supply circuit of a DC-DC converter from the group: flyback converter, single-ended current converter, push-pull flux converter in parallel mode, push-pull flux converter with half-bridge control, push-pull flux converter with full-bridge control, a load voltage is supplied to a load circuit of the DC-DC converter in phase with the supply voltage.

10. The method according to claim 9, wherein a controller of the DC-DC converter drives a power transistor in a supply circuit in response to the provision of a single-phase or two-phase supply voltage.

11. The method according to claim 9, wherein the controller determines an intermediate circuit voltage in the supply circuit of the DC-DC converter and sets a drive frequency for the power transistor proportional to the determined DC link voltage.

12. The method according to claim 11, wherein the controller uses a sensor signal from a temperature sensor for pulse width modulation of the drive frequency for the power transistor.

13. The method according to claim 12, wherein, in a configuration of the DC-DC converter as a push-pull flux converter with full-bridge control, the controller uses phase-shifted pulse width modulation of the drive frequency for the power transistor to achieve a switching operation of the power transistor at vanishing voltage.
